(19) United States
(12) Patent Application Publication
(10) Pub. No.: US 2014/0156393 A1
(43) Pub. Date: Jun. 5, 2014

(54) Method and system for recommending media information post

(71) Applicants: Liu Wu, Shenzhen (CN); Yu Huang, Shenzhen (CN)

(72) Inventors: Liu Wu, Shenzhen (CN); Yu Huang, Shenzhen (CN)

(73) Assignee: TENCENT TECHNOLOGY (SHENZHEN) COMPANY LIMITED, Shenzhen, Guangdong (CN)

(21) Appl. No.: 14/117,568

(22) PCT Filed: Jul. 11, 2012
(86) PCT No.: PCT/CN12/78511

§ 371 Date: Nov. 13, 2013

(30) Foreign Application Priority Data
Sep. 9, 2011 (CN) 201110266957.7

(51) Int. Cl. G06Q 30/02

(52) U.S. Cl. CPC G06Q 30/0251
USPC 705/14.49

(57) ABSTRACT

Disclosed is a media information post recommendation method, including: calculating the recommendation index of a media information post according to the degree of matching between the industry to which a customer product belongs and a channel, as well as the target population covered by each media information post; and recommending a media information post to users according to the calculated recommendation index. Accordingly disclosed is a media information post recommendation system. The embodiments of the present disclosure do not rely on human experience to recommend media information posts, so it is possible to achieve systematic media information post recommendation and improve the recommendation efficiency of the media information posts as well as the releasing effect of media information.

### TECHNICAL FIELD

The present disclosure relates to a media information publication technology, and more particularly to a method and a system for recommending a media information post.

### BACKGROUND

Generally, two problems are encountered in a process of scheduling media information for a certain customer product: the first one is whether a certain media information post is suitable for releasing the media information of the customer and the second one is whether the effect of a certain media information post is good enough to cover a target population expected by a customer.

In the prior art, simple artificial classification is generally applied, e.g. media information of an automobile product is released on an automobile channel, and media information of a women's product is released on a women's channel etc. It can be seen that media information posts and media information of media products are still matched according to human experience currently with relatively low media information post recommendation efficiency and bad media information releasing effect.

In addition, traditional media can hardly acquire detailed and accurate data of a target population currently. Many media personnel who lack systematic research guidance select, during a scheduling process for media information released on the Internet, media information posts merely according to exposure and hits, or select media information posts according to personal releasing experience. However, features of a target population of a customer can be hardly reflected only by exposure or hits. Existing human experience methods, which are unsystematic, cannot be used broadly. In addition, different people may have different experience, thus unable to provide a unified standard.

### SUMMARY

In view of this, the main purpose of embodiments of the present disclosure is to provide a method and a system for recommending a media information post, so as to achieve systematic media information post recommendation and improve the recommendation efficiency of media information post as well as the releasing effect of media information.

To solve the technical problem above, the technical solutions of the embodiments of the present disclosure are realized by the following ways.

A method for recommending a media information post, includes:

calculating a recommendation index of a media information post according to a degree of matching between an industry to which a customer product belongs and a channel, as well as a target population covered by each media information post; and recommending a media information post to users according to a calculated recommendation index.

The degree of matching between the industry to which the customer product belongs and the channel may be represented by a feature matching function, wherein the feature matching function is:

$${w}_{ij} = \frac{{f}_{i , j}}{{\sum }^{ } {L}_{j}} log \frac{N}{{n}_{j}}$$

where f_{i,j} represents the quantity of releasing times of a product of industry Iᵢ on channel Lⱼ, ΣLⱼ represents the sum of carousels on channel Lⱼ, N is the total number of industries, and nⱼ is the quantity of industries to which products released on channel Lⱼ belong.

Attributes of the target population covered by the media information post may consist of age, gender, region and scenario.

The calculating a recommendation index of a media information post may include: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

The recommending a media information post to users according to a calculated recommendation index may include: presenting media information posts according to a descending order of recommendation indexes.

A system for recommending a media information post, includes a recommendation index calculating unit and a media information post recommending unit,

wherein the recommendation index calculating unit is configured to calculate a recommendation index of a media information post according to a degree of matching between an industry to which a customer product belongs and a channel, as well as a target population covered by each media information post;

wherein the media information post recommending unit is configured to recommend a media information post to users according to a recommendation index calculated by the recommendation index calculating unit.

The degree of matching between the industry to which the customer product belongs and the channel may be represented by a feature matching function, wherein the feature matching function is:

$${w}_{ij} = \frac{{f}_{i , j}}{{\sum }^{ } {L}_{j}} log \frac{N}{{N}_{j}}$$

where f_{i,j} represents the quantity of releasing times of a product of industry Iᵢ on channel Lⱼ, ΣLⱼ represents the sum of carousels on channel Lⱼ, N is the total number of industries, and nⱼ is the quantity of industries to which products released on channel Lⱼ belong.

Attributes of the target population covered by the media information post may consist of age, gender, region and scenario.

The recommendation index calculating unit may calculate a recommendation index of a media information post in a following manner: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

The media information post recommending unit may recommend the media information post to the users according to a calculated recommendation index in a following manner: presenting media information posts according to a descending order of recommendation indexes.

The method and system for recommending a media information post according to the embodiments of the present disclosure calculate the recommendation index of a media information post according to the degree of matching between the industry to which a customer product belongs and a channel, as well as the target population covered by each media information post, and recommend a media information post to users according to a calculated recommendation index. The embodiments of the present disclosure do not rely on human experience to recommend media information posts, so it is possible to achieve systematic media information post recommendation and improve the recommendation efficiency of the media information posts as well as the releasing effect of media information.

### BRIEF DESCRIPTION OF THE DRAWINGS

FIG. 1 is a flowchart of a method for recommending a media information post according to an embodiment of the present disclosure;

FIG. 2 is a schematic diagram of a customer requirement input interface according to a specific embodiment of the present disclosure; and

FIG. 3 is a schematic diagram of a user display interface according to a specific embodiment of the present disclosure.

### DETAILED DESCRIPTION

The basic idea of the embodiments of the present disclosure is to calculate a recommendation index of a media information post according to a degree of matching between an industry to which a customer product belongs and a channel, as well as a target population covered by each media information post, and recommend a media information post to users according to the calculated recommendation index.

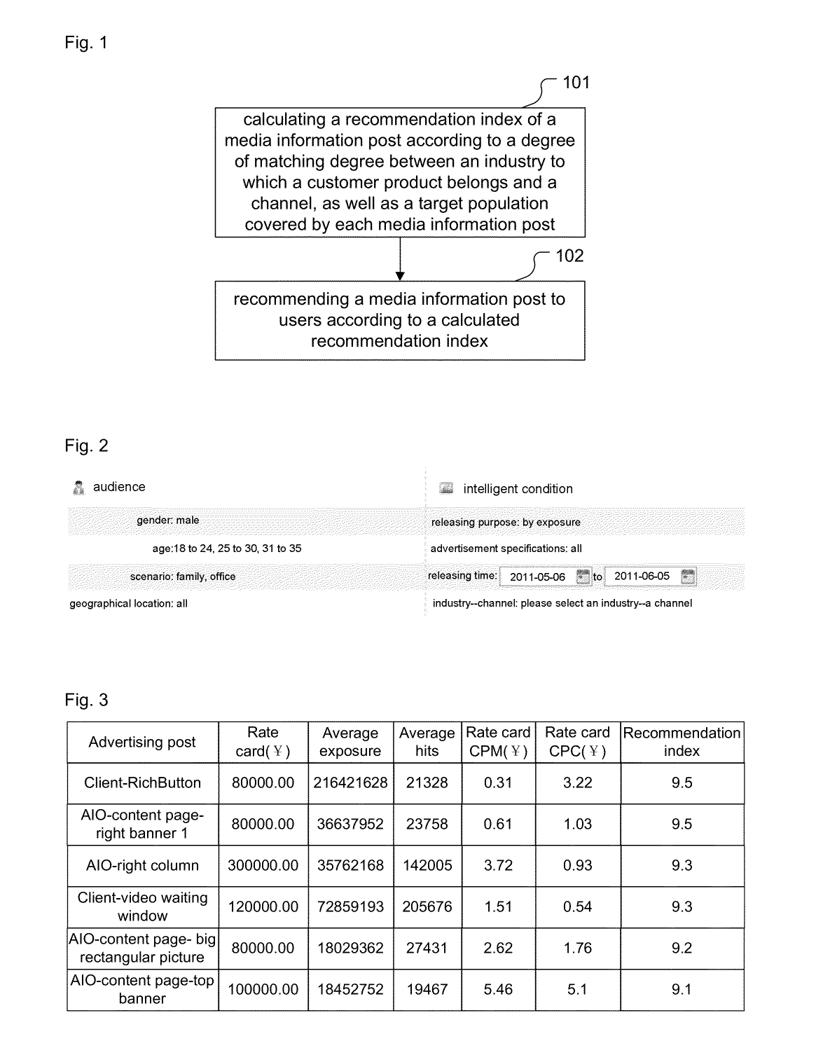

FIG. 1 is a flowchart of a method for recommending a media information post of an embodiment of the present disclosure. As shown in FIG. 1, the method includes:

Step 101: calculating a recommendation index of a media information post according to a degree of matching degree between an industry to which a customer product belongs and a channel, as well as a target population covered by each media information post; and

Step 102: recommending a media information post to users according to a calculated recommendation index.

Here, media information posts may be sorted according to recommendation indexes in a descending order and displayed to the users.

In the embodiments of the present disclosure, a feature matching function may be applied to represent the degree of matching between the customer product and the media information post and the function may be established according to historical releasing data.

A defect of data sparseness may exist if calculation is performed merely by using the historical releasing data of the customer product. Therefore, the degree of matching between the customer product and the media information post is firstly made approximately equivalent to the degree of matching between the industry to which the customer product belongs and the channel to which the media information post belongs.

The feature matching function should satisfy the following conditions:

1) the more a product of the same industry as the customer product is released on a certain channel historically, the more the industry to which the customer product belongs is matched with the channel; and

2) the larger the number of products of other industries released on a certain channel is, the less the channel is matched with the industry to which the customer product belongs. In other words, the more products of various industries released on a channel are, the less the channel is matched with the industry.

To facilitate description, the following symbols are defined first:

I={I₁, I₂, I₃ . . . Iₙ} is a set of industries to which products belong, and L={L₁, L₂, L₃, . . . L_{M-1}, L_{M}} is a channel set.

The releasing frequency of a product of industry Iᵢ on channel Lⱼ is:

$${TF}_{i , j} = \frac{{f}_{i , j}}{{\sum }^{ } {L}_{j}} \qquad ( 1 )$$

where f_{i,j} represents the number of releasing times of the product of industry Iᵢ on channel Lⱼ, and ΣLⱼ represents the sum of carousels on channel Lⱼ, i.e. the sum of carousels of all advertising posts on the channel.

The inverse of the number of releasing times of the product of Iᵢ on Lⱼ is defined as follows:

$${IDF}_{i} = log \frac{N}{{n}_{j}} \qquad ( 2 )$$

where N is the total number of industries, and nⱼ is the quantity of industries to which the products released on channel Lⱼ belong.

Therefore, the feature matching function may be defined as follows:

$${w}_{ij} = \frac{{f}_{i , j}}{{\sum }^{ } {L}_{j}} log \frac{N}{{n}_{j}} \qquad ( 3 )$$

In the embodiments of the present disclosure, population attributes may be set to consist of the following variables when calculating the target population covered by the media information post: z₁ (age), z₂ (gender), z₃ (region) and z₄ (scenario).

setting the vector Z=(z₁,z₂,z₃,z₄);

X₁=single carousel exposure brought about by the customer's target population=φ(z);

X₂=single carousel hits brought about by the customer's target population=ψ(z);

apparently, there are Z₁×Z₂×Z₃×Z₄ combinations of target populations in total. To facilitate real-time online implementation, all combinations are pre-calculated off line.

According to the analysis above, if a channel to which a certain media information post belongs has a higher degree of matching and covers more target populations, the more the channel is expected to be recommended. Therefore, a recommendation index function may be constructed in Step 101 as follows:

R=W1×M+W2×L (4)

where W1 and W2 are respectively the degree of matching between the channel to which the media information post belongs and the industry to which the customer product belongs, and the weight of the quantity of customer's target populations on the media information post, M is the ranking of the degree of matching between the channel to which the media information post belongs and the industry to which the customer product belongs, and L is the ranking of the quantity of the customer's target populations on the media information post.

The algorithms provided by the embodiments of the present disclosure may be applied to any media and any platforms. A solution of the present disclosure will be further described through a specific embodiment below.

1) a feature matrix about industries and media information posts is constructed off line. To facilitate description, the denominator ΣLⱼ in Formula (3) is removed, i.e. the feature function:

$${w}_{ij} = {f}_{i , j} log \frac{N}{{n}_{j}}$$

is applied;

considering the seasonal changes of media information products, a feature matrix as follows may be constructed according to the above feature function formula by using yearly historical releasing data:

$$W = ( \begin{matrix}{w}_{11} & … & {w}_{1 n} \\ ⋮ & ⋱ & ⋮ \\ {w}_{m 1} & … & {w}_{mn}\end{matrix} )$$

where n is the quantity of channels, and m is the quantity of industries.

2) If a customer product belongs to Iᵢ (for example, automobile industry), then (w_{i,1}, w_{i,2}, . . . wᵢₙ), n elements in total of the i^{th} row of matrix W are selected and sorted in a descending order.

3) All combinations of target populations covered by the media information posts are calculated off line.

4) the recommendation indexes of the media information posts are calculated according to customer requirements.

Here, the customer requirements may include one or more of the followings: the industry of a product to be released currently, releasing purposes, and expected target users. Generally, the customer requirements are inputted into a system through an interaction interface, e.g. the customer requirements may be inputted through the interface as shown in FIG. 2.

For a media information post Lⱼ, its recommendation index (taking 30 media information posts for example) may be calculated according to the following method:

1. provided that a channel corresponding to the media information post L(i) is S(j), and the ranking of the media information post in the matching matrix W about industries and channels is R(s), the industry and channel matching value Fmatch is MO);

2. according to an effect function, the media information post L(i) is ranked R(l);

3. M(j) is assumedly divided into segments, the calculated recommendation value is X=0.6*R(s)+0.4R(l) for those great than 300,

the calculated recommendation value is X=0.5R(s)+0.5R(l) for those between 100 and 300,

the calculated recommendation value is X=0.4R(s)+0.6R(l) for those less than 100;

4. a recommendation index is calculated by the formula Y=10−(10−6)/30*X, and X is normalized to a value between Xmin and Xmax (6 to 10); and

5. media information posts are presented to customers according to the descending order of recommendation indexes. The interface for the presentation may be as shown in FIG. 3.

It needs to be noted that the effect function is the quantity of target populations. Since the quantity of target populations includes the quantity of hiting target populations and the quantity of exposed target populations, whether the quantity of hiting target populations or the quantity of exposed target populations is used needs to be determined according to a customer requirement, i.e. whether the release is performed according to the exposure or to the hits on the interface of FIG. 2, in use.

It needs to be noted that, when the degree of matching between the industry to which the customer product belongs and the channel is calculated, the releasing frequency of industry Iᵢ on Lⱼ may be directly defined as f_{i,j} (i.e. the denominator constant is removed), the inverse of the number of releasing times of Iᵢ on Lⱼ may be directly defined as

$$log \frac{1}{{n}_{j}}$$

(i.e. the numerator constant is removed), and these final manifestations are very similar.

Accordingly, the embodiments of the present disclosure further provide a system for recommending a media information post, including: a recommendation index calculating unit and a media information post recommending unit,

wherein the recommendation index calculating unit is configured to calculate a recommendation index of a media information post according to a degree of matching between an industry to which a customer product belongs and a channel, as well as a target population covered by each media information post;

wherein the media information post recommending unit is configured to recommend a media information post to users according to a recommendation index calculated by the recommendation index calculating unit.

The degree of matching between the industry to which the customer product belongs and the channel is represented by a feature matching function, and the feature matching function is:

$${w}_{ij} = \frac{{f}_{i , j}}{\sum {L}_{j}} log \frac{N}{{n}_{j}}$$

where f_{i,j} represents the quantity of releasing times of a product of industry Iᵢ on channel Lⱼ, ΣLⱼ represents the sum of carousels on channel Lⱼ, N is the total number of industries, and nⱼ is the quantity of industries to which products released on channel Lⱼ belong.

Attributes of the target population covered by the media information post consist of age, gender, region and scenario.

The recommendation index calculating unit calculates a recommendation index of a media information post in a following manner: calculate the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

The media information post recommending unit recommends the media information post to the users according to a calculated recommendation index in a following manner: presenting media information posts according to a descending order of recommendation indexes.

It can be seen that the embodiments of the present disclosure construct a feature matching function on the basis of investigating historical releasing experience, describe the degree of matching between a channel and a customer product in a unified manner by using the function, then obtain a target population covered by a media information post according to historical releasing data, finally calculate a recommendation index according to the degree of matching and the target population, and recommend the first N media information posts (N may be set as required by a customer) according to the sizes of recommendation indexes.

The foregoing descriptions are merely preferred embodiments of the present disclosure, but are not intended to limit the scope of protection of the present disclosure.

1. A method for recommending a media information post, comprising:
calculating a recommendation index of a media information post according to a degree of matching between an industry to which a customer product belongs and a channel, as well as a target population covered by each media information post; and
recommending a media information post to users according to a calculated recommendation index.

2. The method according to claim 1, wherein the degree of matching between the industry to which the customer product belongs and the channel is represented by a feature matching function, and the feature matching function is:
$${w}_{ij} = \frac{{f}_{i , j}}{{\sum }^{ } {L}_{j}} log \frac{N}{{n}_{j}}$$
where f_{i,j} represents the quantity of releasing times of a product of industry Iᵢ on channel Lⱼ, ΣLⱼ represents the sum of carousels on channel Lⱼ, N is the total number of industries, and nⱼ is the quantity of industries to which products released on channel Lⱼ belong.

3. The method according to claim 1, wherein attributes of the target population covered by the media information post consist of age, gender, region and scenario.

4. The method according to claim 1, wherein the calculating a recommendation index of a media information post comprises: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

5. The method according to claim 1, wherein the recommending a media information post to users according to a calculated recommendation index comprises: presenting media information posts according to a descending order of recommendation indexes.

6. A system for recommending a media information post, comprising: a recommendation index calculating unit and a media information post recommending unit,
wherein the recommendation index calculating unit is configured to calculate a recommendation index of a media information post according to a degree of matching between an industry to which a customer product belongs and a channel, as well as a target population covered by each media information post;
wherein the media information post recommending unit is configured to recommend a media information post to users according to a recommendation index calculated by the recommendation index calculating unit.

7. The system according to claim 6, wherein the degree of matching between the industry to which the customer product belongs and the channel is represented by a feature matching function, and the feature matching function is:
$${w}_{ij} = \frac{{f}_{i , j}}{\sum {L}_{j}} log \frac{N}{{n}_{j}}$$
where f_{i,j} represents the quantity of releasing times of a product of industry Iᵢ on channel Lⱼ, ΣLⱼ represents the sum of carousels on channel Lⱼ, N is the total number of industries, and nⱼ is the quantity of industries to which products released on channel Lⱼ belong.

8. The system according to claim 6, wherein attributes of the target population covered by the media information post consist of age, gender, region and scenario.

9. The system according to claim 6, wherein the recommendation index calculating unit calculates a recommendation index of a media information post in a following manner: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

10. The system according to claim 6, wherein the media information post recommending unit recommends the media information post to the users according to a calculated recommendation index in a following manner: presenting media information posts according to a descending order of recommendation indexes.

11. The method according to claim 2, wherein the calculating a recommendation index of a media information post comprises: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

12. The method according to claim 3 wherein the calculating a recommendation index of a media information post comprises: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

13. The method according to claim 2, wherein the recommending a media information post to users according to a calculated recommendation index comprises: presenting media information posts according to a descending order of recommendation indexes.

14. The method according to claim 3, wherein the recommending a media information post to users according to a calculated recommendation index comprises: presenting media information posts according to a descending order of recommendation indexes.

15. The system according to claim 7, wherein the recommendation index calculating unit calculates a recommendation index of a media information post in a following manner: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

16. The system according to claim 8, wherein the recommendation index calculating unit calculates a recommendation index of a media information post in a following manner: calculating the recommendation index according to a recommendation index function R=W1×M+W2×L, where W1 and W2 are respectively the degree of matching between the channel to which the media information post belongs and the industry to which the customer product belongs, and a weight of the quantity of customer's target populations on the media information post, M is a ranking of the degree of matching between the channel to which the media information post belongs and the industry to which the customer product belongs, and L is a ranking of the quantity of the customer's target populations on the media information post.

17. The system according to claim 7, wherein the media information post recommending unit recommends the media information post to the users according to a calculated recommendation index in a following manner: presenting media information posts according to a descending order of recommendation indexes.

18. The system according to claim 8, wherein the media information post recommending unit recommends the media information post to the users according to a calculated recommendation index in a following manner: presenting media information posts according to a descending order of recommendation indexes.
